(19) United States
(12) Patent Application Publication
(10) Pub. No.: US 2026/0275202 A1
(43) Pub. Date: Sep. 17, 2026

(54) ELECTRIC FURNACE WITH THERMAL PROFILE MANAGEMENT & METHODS OF STEAM CRACKING WITH ELECTRIC FURNACE

(71) Applicant: SABIC Global Technologies B. V., Bergen OP Zoom (NL)

(72) Inventor: Arno Johannes Maria OPRINS, Geleen (NL)

(73) Assignee: SABIC Global Technologies B. V., Bergen OP Zoom (NL)

(21) Appl. No.: 19/167,903

(22) PCT Filed: Mar. 8, 2024
(86) PCT No.: PCT/EP2024/056234

§ 371 Date: Sep. 23, 2025

(30) Foreign Application Priority Data
Mar. 24, 2023 (EP) 23164116.8

(51) Int. Cl. C10G 9/36; H05B 3/62

(52) U.S. Cl. CPC C10G 9/36; H05B 3/62

(57) ABSTRACT

Radiative electric furnaces and methods of using such furnaces (e.g., for steam cracking) are disclosed. Furnaces can include heating elements configured to add thermal energy to a heating chamber, hollow coils extending from a first end of a heating chamber toward a second end of the heating chamber and between the heating elements, such that process fluid can be heated as it passes through the coil toward the second end. Furnaces can include one or more fluid inlet conduits for delivering the process fluid to inlet sections of heating coils, with each fluid inlet conduit having a preheat section that extends through at least a part of the heating chamber closer to the second end than to the first end to receive thermal radiation from a portion of the heating elements. The preheat section can advantageously preheat the process fluid and reduce the maximum temperature experienced by the heating elements.

### FIELD OF DISCLOSURE

The present disclosure is generally related to processes for producing chemicals and, more particularly but not by way of limitation, to a radiative electric furnace for steam cracking, and methods of steam cracking using such a radiative electric furnace.

### BACKGROUND

Chemical synthesis plants are utilized to provide a variety of chemicals. Often, a dedicated fuel is burned or combusted to provide heat of reaction for chemical synthesis, energy to heat one or more process streams, energy to vaporize liquids (e.g., boil water used as a diluent), energy to do work (e.g., drive a compressor or pump), or energy for other process operations throughout the chemical synthesis plant. Such burning or combustion of fuels results in the production of flue gases that contain CO₂, which can be harmful to the environment, and also results in a loss of energy efficiency of the process. Likewise, steam is often conventionally utilized as a plant-wide heat and/or energy transfer fluid within chemical synthesis plants. The steam utilized for the heat and/or energy transfer is often produced via the combustion of a fuel, resulting in the production of additional flue gas and further energy efficiency losses during the chemical synthesis.

However, the electrification of certain components in chemical synthesis plants presents additional issues and challenges. For example, in steam cracking processes, electric furnaces pyrolysis reactors may present issues or may be subject to considerations that are different than and/or not necessarily present in combustion-driven furnace pyrolysis reactors.

### SUMMARY

The present disclosure includes radiative electric furnaces with thermal profile management. A radiative electric furnace with heating elements on opposing sides of a heating chamber and coils (e.g., straight, U-shaped, serpentine, etc.) extending along at least a majority of the length of the chamber may exhibit a thermal gradient along the heating elements. For example, when the coils extend in a single, common direction from a relatively cooler portion at a first end of the chamber to a relatively hotter portion at a second end of the chamber, the second end of the chamber will be hotter overall. As another example, in a similar furnace with U-shaped coils, a first end region of the chamber includes both the relatively cooler inlet sections of the U-shaped coils and the relatively hotter outlet sections of the coils, while a second end region of the chamber includes the medial sections of the U-shaped coils. In such U-shaped coils, various factors e.g., difference surface areas and mass distributions between the inlet sections and the outlet sections of the coils, the average coil temperature at the second end of the chamber may be typically higher than the average coil temperature at the first end, which can similarly result in the second end of the chamber being hotter overall.

In either configuration, the higher temperature in the second end region of the chamber results in the heating elements at the second end “seeing” a higher temperature and therefore, due to radiative heating, results in the heating elements at the second end experiencing higher temperatures than heating elements elsewhere in the chamber, which higher temperatures may negatively impact the useful life and/or durability of those heating elements. Additionally, for an electric furnace in a steam-cracking process, the temperature of fluids entering the electric furnace may be lowered relative to the temperature of such fluids entering a conventional (combustion) furnace, which is intended to reduce the risk of coking/fouling in the electric heater before entering the radiative heating chamber and thereby allow for additional heat exchange area of a preheat section through which to pass the cool fluids and thereby lower the peak temperatures experienced by heating elements.

To balance those differences, and therefore reduce the temperature gradient in the heating elements, the present furnaces add pre-heating sections of tubing or rearrange coils to provide additional capacity to absorb thermal energy in the second end region of the heating chamber. For example, in some of the present furnaces, a pre-heating section of an inlet tubing extends across at least a portion of a width of the chamber to allow the inlet conduit(s) carrying the “cold” process fluid to absorb thermal radiation emitted from hotter surfaces (e.g., one or more heating element(s)) in the second end region, and thereby reduce the maximum temperature experienced by the heating elements in the second end region to a temperature that is closer to the maximum temperature experienced by the heating elements in the first end region. In other examples of the present furnaces, a first portion of the U-shaped coils are reversed in direction such that the first portion of the U-shaped coils are oriented in a first direction, and a second portion of the U-shaped coils are oriented in a second direction that is opposite to the first direction, such that the first and second ends of the radiative heating chamber are thermally balanced.

Some configurations of the present radiative electric furnaces comprise: a housing defining a radiant heating chamber; one or more first electric heating elements disposed on a first side of the chamber; one or more second electric heating elements disposed on a second side of the chamber and spaced apart from the first electric heating element(s); and a plurality of hollow coils extending in the chamber from the first end toward the second end, each of the coils having an inlet section and an outlet section. Such configurations further comprise one or more fluid inlet conduits in fluid communication with the inlet sections of the coils. In some such configurations, the radiant heating chamber has a first end and a second end separated from the first end by a chamber length, and a second end region that is defined by the 25% or less of the chamber closest to the second end. In such configurations, the fluid inlet conduit(s) each comprise a pre-heating section extending in at least the second end region of the chamber to receive thermal radiation from a portion of the heating elements, and a connection section extending from the pre-heating section to the inlet sections of the coils; and the furnace is configured to receive fluid into the fluid inlet conduit(s) such that the fluid flows sequentially through the pre-heating section of each fluid inlet conduit, the connection section of each fluid inlet conduit, and the coils.

In some of the foregoing configurations of the present electric furnaces, the pre-heating section of the inlet conduit(s) flows across the second end region of the chamber, for example in one or more passes across a transverse dimension of the chamber (e.g., in a serpentine or spiral path).

In some of the foregoing configurations of the present electric furnaces, each coil has an inlet section, an outlet section, and a medial section between the inlet section and outlet section, where the inlet section and outlet section extend in a first direction from the first end of the chamber toward the second end, and the medial section is disposed closer to the second end of the chamber than to the first end; and where at least part of the pre-heating section is disposed between the second end of the chamber and the medial sections of the coils.

In some of the foregoing configurations of the present electric furnaces, the second end region is defined by the 10% of the chamber closest to the second end.

In some of the foregoing configurations of the present electric furnaces, the preheating section defines a plurality of flowpaths.

In some configurations of the present radiative electric furnaces, the inlet section of each of the coils comprises a plurality of tubes each of which is in fluid communication with the medial section of that coil and with the inlet section of the inlet conduit(s).

Other configurations of the present radiative electric furnaces comprise: a housing defining a radiant heating chamber having a first end and a second end separated from the first end by a chamber length; one or more first electric heating elements disposed on a first side of the chamber; one or more second electric heating elements disposed on a second side of the chamber and spaced apart from the first electric heating element(s); a plurality of hollow first coils; and a plurality of hollow second coils. In some such configurations, each first coil having an inlet section, an outlet section, and a medial section between the inlet section and outlet section, where the inlet section and outlet section extend in a first direction from the first end of the chamber toward the second end, and the medial section is disposed closer to the second end of the chamber than to the first end; each second coil having an inlet section, an outlet section, and a medial section between the inlet section and outlet section, where the inlet section and outlet section extend in a second direction from the second end of the chamber toward the first end, and the medial section is disposed closer to the first end of the chamber than to the second end. Some such configurations further comprise: one or more fluid inlet conduits in fluid communication with the inlet sections of the first and second coils; and the furnace is configured to receive fluid into fluid inlet conduit(s) such that the fluid flows sequentially through the inlet sections of the first and second coils, the medial sections of the first and second coils, and the outlet sections of the first and second coils. In some such configurations, the inlet section of each of the first and second coils comprises a plurality of tubes each of which is in fluid communication with the medial section of that coil and with the inlet conduit(s).

In some of the foregoing configurations of the present electric furnaces, the first and second electric heating elements are configured to reach a maximum temperature in excess of 1050° C.

In some of the foregoing configurations of the present electric furnaces, the fluid inlet conduit(s) is coupled to the inlet sections of the coils via a manifold.

Some of the present steam cracking systems comprise: a quench unit having an quench unit inlet; and one of the present electric furnaces with the outlet sections of the coils coupled to the quench unit inlet. In some such systems, the quench unit comprises a transfer line exchanger (TLE).

Some implementations of the present methods of steam cracking comprise: directing a fluid (e.g., a mixture of hydrocarbon feedstock and steam) from one or more fluid inlet conduits to inlet sections of hollow coils that extend from a first end of a furnace heating chamber toward a second end of the furnace heating chamber, and between first and second electric heating elements disposed on opposing sides of the heating chamber, such that the fluid is heated to a reaction temperature at which a cracking reaction occurs; where, before reaching the inlet sections of the hollow coils, a preheat section of each fluid inlet conduit(s) pass between the heating elements, at a position closer to the second end then to the first end, such that the preheat section(s) absorb thermal radiation from at least a portion of the heating elements and the temperature of the fluid increases in the preheating section. Some such implementations of the present methods further comprise: directing the fluid from the outlet sections of the coils to an inlet of a quench unit to reduce the temperature of the fluid to below the reaction temperature and slow or stop the cracking reaction. In some such implementations, the fluid is a mixture that includes a hydrocarbon feedstock comprising at least one component selected from the list of components consisting of: naptha, liquified petroleum gas (LPG), and ethane.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, in such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, an apparatus, device or system that is configured in a certain way is configured in at least that way, but it can also be configured in other ways than those specifically described.

Any embodiment of any of the present apparatuses and methods can consist of or consist essentially of—rather than comprise/include/contain/have-any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 depicts block flow diagram of a generalized steam cracking plant or process.

FIG. 2 depicts a block flow diagram of the pyrolysis reaction section of the plant or process of FIG. 1.

FIGS. 3A and 3B, respectively, depict front and side cross-sectional views of a first example of an electric furnace for use in the pyrolysis reaction section of FIG. 2.

FIG. 3C depicts an upper cross-sectional view of the furnace of FIGS. 3A and 3B, taken along the plane 3C-3C of FIGS. 3A and 3B.

FIGS. 4A and 4B, respectively, depict front and side cross-sectional views of a first example of the present electric furnaces with thermal profile management for use in the pyrolysis reaction section of FIG. 2.

FIG. 4C depicts an upper cross-sectional view of the furnace of FIGS. 3A and 3B, taken along the plane 4C-4C of FIGS. 4A and 4B.

FIG. 5 depicts a front cross-sectional view of a second example of the present electric furnaces with thermal profile management for use in the pyrolysis reaction section of FIG. 2.

FIGS. 6A and 6B, respectively, depict front and side cross-sectional views of a third example of the present electric furnaces with thermal profile management for use in the pyrolysis reaction section of FIG. 2.

### DETAILED DESCRIPTION

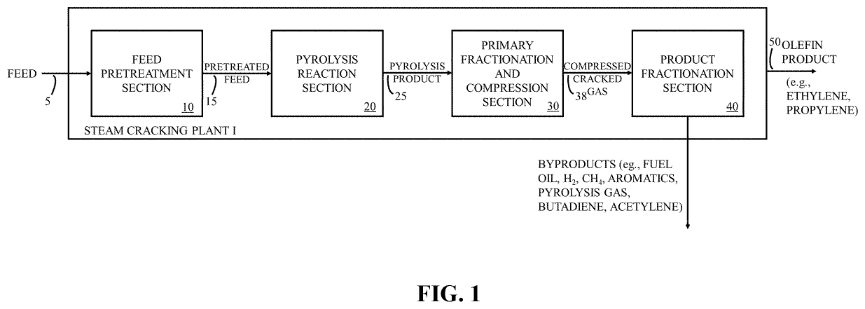

Referring now to the drawings, and more particularly to FIG. 1, shown there is a block flow diagram of an example of a generalized steam cracking plant or process, which includes one or more of the following process sections for converting a feed stream 5 into a desired olefin product stream 50: a feed pretreatment section 10, a pyrolysis reaction section 20, a primary fractionation and compression section 30, a product fractionation (separation) and compression section 40, or a combination thereof. Such sections will be described briefly in the next few paragraphs, and in more detail hereinbelow.

Feed pretreatment section 10 can be configured to adjust the pressure of a feed 5, possibly remove undesirable components (e.g., carbon dioxide (CO₂), mercury, water) from a feed, combine an incoming feed with a stored feed to minimize variations in the composition of the feed to the pyrolysis reaction section 20, and/or preheat the feed 5, to provide a pretreated feed stream 15.

Pyrolysis reaction section 20 can comprise at least one steam cracker or ‘pyrolysis’ furnace configured to crack hydrocarbons in the presence of steam to produce a cracked gas stream and a transfer line exchanger (TLE) or other heat transfer device to quench (and optionally harvest heat from) the cracked gas stream to provide a cooled cracked stream 25. Conventionally, the furnaces of a steam cracking plant create a high temperature environment by the combustion of fuels such as methane and hydrogen, which produces carbon dioxide emissions from a conventional steam cracking plant/process. However, in the present embodiments, the furnace is instead a radiative electric furnace in which electric heating elements provide heat or thermal energy in a heating chamber to tubes through which the feed stream flows.

The primary fractionation and compression section 30 can be configured to provide further heat recovery from and quenching of the cooled cracked gas stream 25, remove one or more components (e.g., fuel oil, hydrogen sulfide, carbon dioxide, water, or a combination thereof) from the cracked gas stream 25, and/or compress the cracked gas stream 25, thus providing a compressed cracked gas stream 38.

The product fractionation or separation section 40 can be configured to fractionate the compressed cracked gas stream 38, selectively hydrogenate one or more streams produced during the fractionation, and provide one or more olefin (e.g., ethylene, propylene) product streams 50. The product fractionation or separation section 40 may also provide one or more byproduct streams 60, such as, without limitation, a C₁ stream, a C₂ saturate stream, a C₃ saturate stream, a C₄ saturate stream, an acetylene stream, a butadiene stream, a 1-butene stream, an isobutylene stream, an aromatics stream, a hydrogen stream, a pyrolysis gasoline stream, and/or a fuel oil stream, or streams comprising a combination of these components. Some of these streams may be recycled to one or more sections of the steam cracking plant. For example, without limitation, the C₂, C₃, and/or C₄ saturate streams may be recycled to one or more of the pyrolysis furnaces of the pyrolysis reaction section 20, hydrogen may be purified (e.g., via a pressure swing adsorption unit (PSA) and a methanation reactor to remove CO) and recycled to a hydrogenation reactor (e.g., a C₂, C₃, acetylene, or di-olefin hydrogenator) and/or utilized as a fuel source (e.g., via fuel cell). The C₁ stream may also be recycled for use as a fuel (e.g., for the production of hydrogen therefrom).

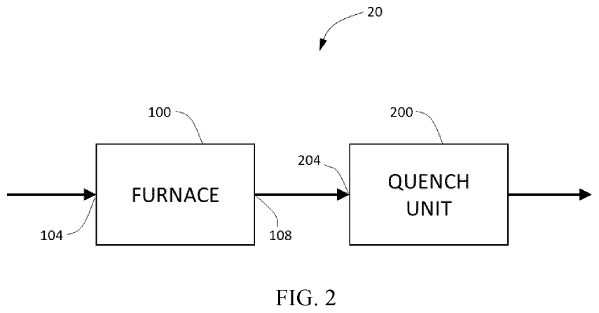

Referring now to FIG. 2, and as also noted above, pyrolysis reaction section 20 can comprise at least one steam cracker or ‘pyrolysis’ furnace 100 configured to crack hydrocarbons in the presence of steam to produce a cracked gas stream, and a quench unit 200 (e.g., a transfer line exchanger (TLE) or other heat transfer device) to quench (and optionally harvest heat from) the cracked gas stream to provide a cooled cracked stream 25. As shown in FIG. 2, the furnace generally includes a fluid inlet 104 and a fluid outlet 108, with the fluid outlet 108 in fluid communication with a fluid inlet 204 of the quench unit 200.

FIGS. 1 and 2 depict one example of a steam cracking system for illustration purposes, but the present radiative electric furnaces can be used in any of various steam cracking, steam methane reforming (SMR), and/or other furnace systems and processes, for example, with furnace duties of from 15 MW to 100 MW (e.g., greater than any one of, or between any two of: 15 MW, 25 MW, 50 MW, 75 MW, and/or 100 MW).

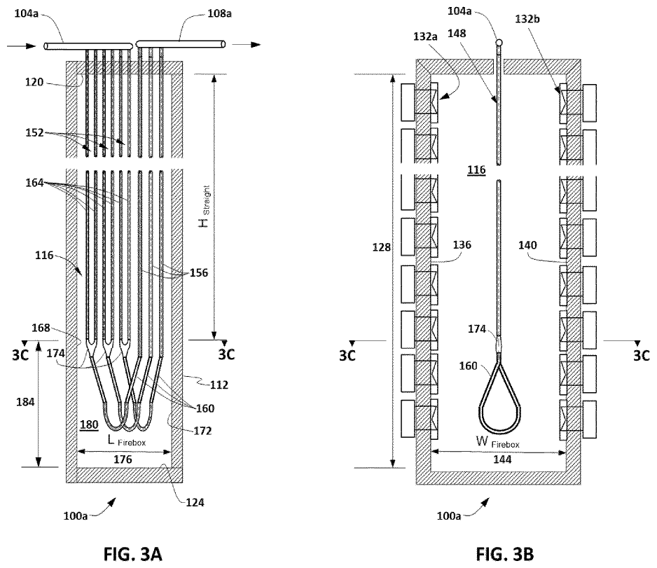

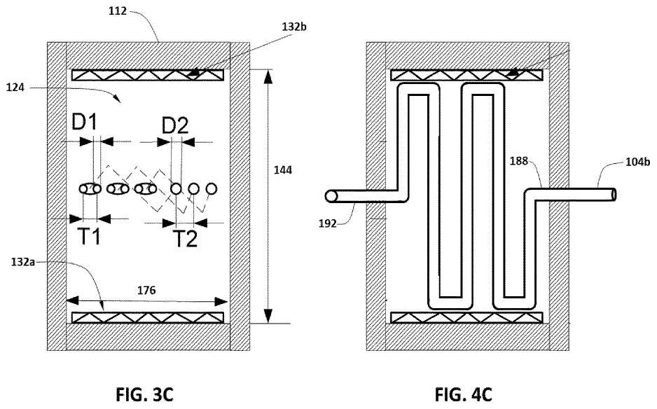

Referring now to FIGS. 3A-3C; FIG. 3A depicts a front cross-sectional view of a first example 100a of a an electric furnace for use in the pyrolysis reaction section of FIG. 2; FIG. 3B depicts a side cross-sectional view of furnace 100a; and FIG. 3C depicts an upper cross-sectional view of furnace 100a taken along the plane 3C-3C of FIGS. 3A and 3B. As shown, furnace 100a includes a housing 112 that defines a radiant heating chamber 116 having a first end 120 and a second end 124 separated from the first end 120 by a chamber length 128. In this configuration, furnace 100a also includes one or more (e.g., as depicted, a plurality of) first electric heating elements 132a disposed on a first side 136 of the chamber; and one or more (e.g., as depicted, a plurality of) second electric heating elements 132b disposed on a second side 140 of the chamber that is separated from the first side by a chamber width 144. As shown, second electric heating element(s) 132b are therefore spaced apart from first electric heating element(s) 132a. In this configuration, the heating elements include a plurality of heating elements extending along a majority of the length 128 of each of the first and second walls. In other embodiments, a single large heating element may be disposed on one or both of the first and second sides 136, 140 of the chamber.

As shown, furnace 100a also includes a plurality of hollow coils 148 extending in the chamber from first end 120 toward second end 124, each of the coils having an inlet section 152 and an outlet section 152. In the depicted configuration, each coil 148 has an inlet section 152, an outlet section 156, and a medial section 160 between the inlet section 152 and outlet section 156. For each coil 148, the inlet section 152 and outlet section 156 extend in a first direction from the first end 120 of the chamber toward the second end 124, and the medial section 160 is disposed closer to the second end 124 of the chamber than to the first end 120. In this embodiment, each inlet section 152 includes two tubes 164 that split the inlet flow into two paths with greater surface area per unit of mass flowrate and, thereby, more-rapid (and greater overall) increase in temperature through the inlet section 152 than through the outlet section 156. As can be seen in FIG. 3C, each tube 164 of inlet section 152 has a first diameter, D1, and is separated from other adjacent tube of the respective inlet section 152 by a center-to-center first distance, T1; and each tube of outlet section 156 has a second diameter, D2, and is separated from the tube of the next-adjacent outlet section 156 by a center-to-center second distance, T2. As also shown in FIG. 3C, the chamber also has a front side 168 and a rear side 172 separated from the front side 168 by a depth 176. In this configuration, the tubes of the inlet section 152 and outlet section 156 are each disposed equidistant from the first and second sides 136, 140 to balance the amount of thermal energy the inlet and outlet sections 152, 156 absorb from each of the heating elements. Various other configurations can include any number of tubes in any of various symmetric or asymmetric configurations (e.g., with inlets grouped together and outlets grouped together).

The medial section 160 of each coil 148 extends from a first end at the inlet section 152 to a second end at the outlet section 156, and defines the U-shaped change in direction of each coil. In the depicted configuration with two tubes in each inlet section 152 of the coils, the first end of each medial section 160 includes a Y-connection or splitter 174 that combines the two smaller tubes of the inlet section 152. In the depicted configuration, the medial sections 160 are disposed in a second end region 180 having a length 184 and defined by the 25% of the chamber (e.g., by volume or length) closest to the second end 124. In other configurations, second end region 180 can be defined by a different portion of the chamber, for example, less than any one of or between any two of: 30%, 25%, 20%, 15%, 10%, and/or 5% of the chamber (by volume and/or length).

In this configuration, inlet sections 152 and outlet sections 156 are each defined by straight sections of tubing, and medial sections 160 extend between those straight pieces of tubing. The inlet and outlet sections 152, 156 may vary in shape in other configurations. For example, in the depicted configuration, the inlet and outlet sections 152, 156 extend through the housing at the first end of the chamber; however, in other configurations, the inlet and outlet sections 152, 156 may extend laterally inward in a region of the chamber that is closer to the first end 120 than to the second end 124.

A fluid inlet conduit 104a is in fluid communication with the inlet sections 152 of the coils 148, and a fluid outlet tube is in fluid communication with the outlet sections 156 of the coils, such that fluid flowing into the inlet conduit 104a flows sequentially through the inlet sections 152 of the coils 148, the medial sections 160 of the coils 148, and the outlet sections 156 of the coils 148, to the fluid outlet tube 108a. In this configuration, the fluid may for example enter the inlet conduit 104a at a temperature of 600° C. and exit the outlet tube 108a at a temperature of 850° C.

In this configuration, when a given power level is supplied to each of heating elements 132a, 132b, the heating element(s) or portions of the heating element(s) closest to the second end 124 will experience a higher temperature than those closest to the first end 120. For example, in this configuration in which the inlet section 152 of each coil 148 is split into two tubes, the fluids in the coils reach a temperature in medial sections 160 of the coils 148 that is higher than the midpoint of the fluid's inlet and outlet temperatures. As a result, the medial sections 160 of the coils 148 also exhibit a temperature that is higher than the average of the temperatures of the inlet sections 152 and outlet sections 156 at first end 120. This, combined with the fact that the medial sections do not extend all the way to second end 124 of the chamber, means that near second end 124, the average temperature of the exposed surfaces is defined primarily by the heating elements themselves, such that heating element(s) 132a, 132b at the second end 124 of the chamber experience a higher temperature than the heating element(s) 132a, 132b at the first end 120 of the chamber (where the greater exposed surface area and lower average temperature of the coils causes the coils to absorb relatively more and emit relatively less thermal radiation).

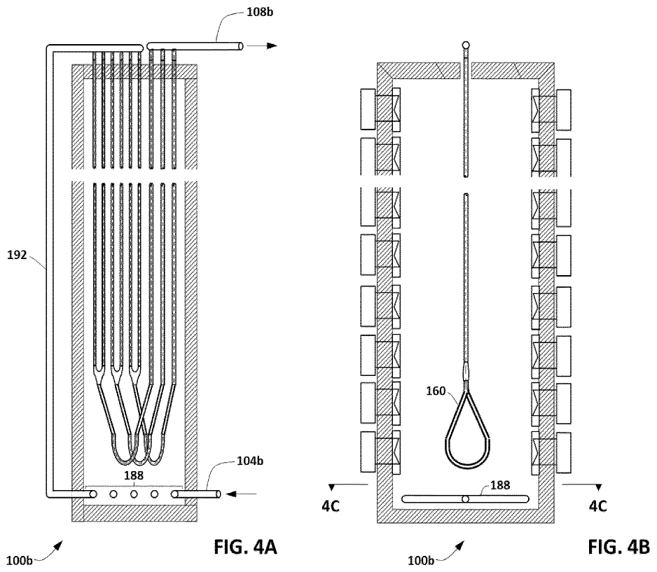

Referring now to FIGS. 4A-4C; FIG. 4A depicts a front cross-sectional view of a first example 100b of the present electric furnaces with thermal profile management for use in the pyrolysis reaction section of FIG. 2; FIG. 4B depicts a side cross-sectional view of furnace 100b; and FIG. 4C depicts an upper cross-sectional view of furnace 100b taken along the plane 4C-4C of FIGS. 4A and 4B. Furnace 100b is similar to furnace 100a, with the primary exception that the inlet conduit 104b of furnace 100b includes a pre-heating section 188 configured to absorb additional thermal energy from the heating elements 132 (a), 132 (b) near the second end 124 of the chamber and thereby reduce temperature spikes in those heating elements (or portions of those heating elements). As such, FIGS. 4A-4C omit the reference numerals for elements that are the same as those in the furnace 100a of FIGS. 3A-3C. As shown in FIG. 4A, the fluid inlet conduit 104b of furnace 100b extends through housing 112 such that pre-heating section 188 extends laterally across (in the depth 176 direction, the width 144 direction, or both) at least a portion of the chamber in second end region 180, and a connection section 192 of the fluid inlet conduit then extends from the pre-heating section 188 to the inlet sections 152 of the coils 184. At least part (e.g., all, as shown) of the pre-heating section 188 can be disposed between the second end 124 of the chamber and the medial sections 160 of the coils 148. At least part (e.g., all, as shown) of connection section 192 of the fluid inlet conduit can extend outside of the housing, and that part outside the housing can be thermally insulated. In other configurations, the connection section be disposed inside the heating chamber.

As shown in FIG. 4C, in the depicted configuration, the pre-heating section 188 includes a tube entering the chamber through the housing and “snaking” across the chamber by reversing direction (up and down in the depicted orientation) several times as the tube proceeds laterally across the chamber to increase the length (and therefore surface area) of the tube that is available to absorb thermal energy. For example, in the depicted configuration, the pre-heating section of the inlet conduit flows laterally across the second end region of the chamber by a distance (or tube length) that is at least three times the chamber width 144. In other configurations, the particular path and exposed tube length of the pre-heating section 188 can vary; by way of example, the exposed tube length in the chamber can be greater than any one of, or between any two of: 100%, 150%, 200%, 250%, 300%, 350%, 400%, 450%, and/or 500% of the chamber width 144. By way of further example, in other configurations, the path of the pre-heating section 188 can be a spiral and/or can be arranged on multiple levels or layers in the direction of chamber length 128.

In operation, furnace 100b is configured to receive fluid into fluid inlet conduit 104b such that the fluid flows sequentially through the pre-heating section 188 of the fluid inlet conduit, the connection section 192 of the fluid inlet conduit, the inlet sections 152 of the coils 148, the medial sections 160 of the coils 148, and the outlet sections 156 of the coils 158, to the fluid outlet 108a. In this configuration, the fluid may for example enter the inlet conduit 104a at a first temperature of 600° C. and be preheated in the pre-heating section 188 to a second temperature of 650° C. or 700° C., such that the fluid enters the inlet sections 152 of the first and second coils 148a, 148b at the second temperature (650° C. or 700° C.) and exits the outlet tube 108a at a final temperature of 850° C.

In this way, fluid enters the pre-heating section 188 when the fluid is at the lowest temperature in the furnace and can absorb thermal energy from the heating elements 132a, 132b near the second end 124 of the heating chamber and thereby reduce temperature spikes in those heating elements (or portions thereof). The fluid is thereby pre-heated such that the fluid enters the inlet sections 152 of the coils 148 at a relatively higher temperature and thereby raises the average temperature between the inlet and outlet sections 152, 156 at the first end 120 of the chamber, thereby reducing the difference between average temperatures near the first and second ends of the heating chamber.

In other configurations, the preheat section of the inlet conduit(s) can have any of various configurations that, similar to the example of FIGS. 4A-4B, introduces exposed surface area with a lower temperature than that of the heating elements (and ideally lower than that of the medial or other adjacent section of the coils). The addition of such additional surface area at such a lower temperature reduces the amount of thermal radiation reflected or emitted back to the heating elements, and thereby reduce the maximum temperatures experienced by the heating elements near or in a field of view of the preheating section.

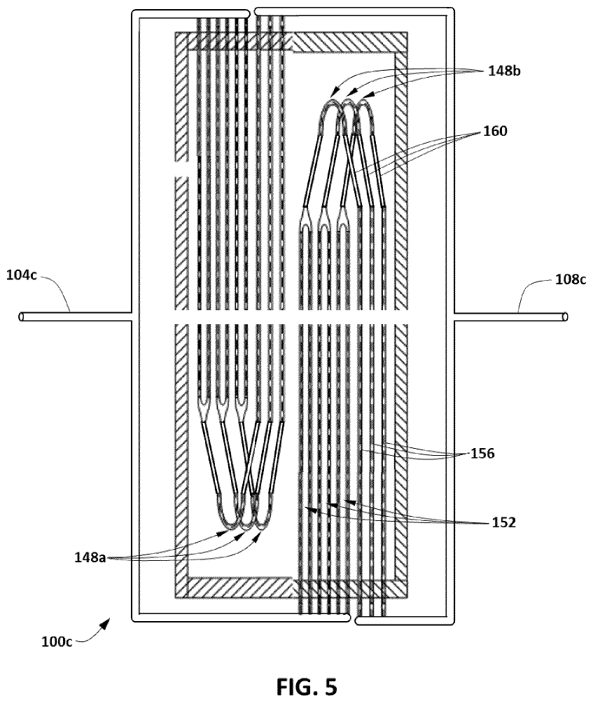

FIG. 5 shows a front cross-sectional view of a second example 100c of the present electric furnaces with thermal profile management for use in the pyrolysis reaction section of FIG. 2. Furnace 100c is similar to furnace 100a, with the primary exception that furnace 100c includes both a first set of coils 148a that is similar to coils 148 of furnace 100a, and a second set of coils 148b that is similar to but reversed in direction relative to the first set of coils. As such, FIG. 5 omits the reference numerals for elements that are the same as those in the furnace 100a of FIGS. 3A-3C. As shown in FIG. 5, the second coils 148b are oriented in the opposite direction of the first coils 148a, i.e., such that the inlet sections 152 and outlet sections 156 extend in a second direction from the second end 124 of the chamber 116 toward the first end 120, and the medial section 160 is disposed closer to the first end 120 than to the second end 124. As can be seen in FIG. 5, inlet conduit 104c is in fluid communication (e.g., via one or more manifolds) with the inlet sections 152a, 152b of each of first and second coils 148a, 148b; and outlet tube 104c is in fluid communication (e.g., via one or more manifolds) with the outlet sections 156a, 156b of each of the first and second coils 148a, 148b.

In the depicted configuration, the medial sections 160 of second coils 148b are disposed in a first end region 196 having a length 198 and defined by the 25% of the chamber (e.g., by volume or length) closest to the first end 120. In other configurations, first end region 198 can be defined by a different portion of the chamber, for example, less than any one of or between any two of: 30%, 25%, 20%, 15%, 10%, and/or 5% of the chamber (by volume and/or length).

In operation, furnace 100c is configured to receive fluid into fluid inlet conduit 104c such that the fluid flows sequentially through the inlet sections 152 of the first and second coils 148a, 148b, the medial sections 160 of the first and second coils 148a, 148b, and the outlet sections 156 of the first and second coils 148a, 148b, to the fluid outlet 108c.

In this configuration, the first and second ends 120, 124 of the chamber are thermally balanced because each end has the same number of inlet sections 152, outlet sections 156, and medial sections 160, such that heating elements 132a, 132b at each end experience similar temperature and thermal profiles.

Other configurations can have any suitable configuration of coils, such as, for example more than two sets of coils.

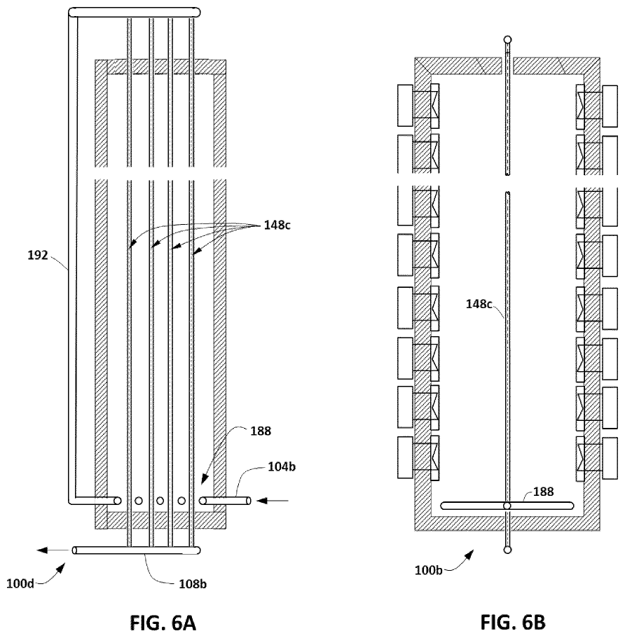

FIGS. 6A and 6B, respectively, depict front and side cross-sectional views of a third example 100d of the present electric furnaces with thermal profile management for use in the pyrolysis reaction section of FIG. 2. Furnace 100d is similar to furnace 100c, with the exception that coils 148c enter first end 120 of the chamber and exit second end 124 of the chamber, as shown. In this configuration, fluid in the coils increases in temperature as it flows from the first end to the second. As such, the inclusion of preheat section 188 performs a similar function in furnace 100d as in furnace 100b, specifically, by facilitating radiative heat transfer to the preheat section 188 that lowers the maximum temperature to which the heating elements at the second end are exposed.

### * * *

Additional details about various components of steam cracking plants and processes can be found in International Patent Application Publication No. WO2020/150244, which is incorporated by reference in its entirety.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A radiative electric furnace comprising:
a housing defining a radiant heating chamber having a first end and a second end separated from the first end by a chamber length, and a second end region defined by the 25% or less of the chamber closest to the second end;
one or more first electric heating elements disposed on a first side of the chamber;
one or more second electric heating elements disposed on a second side of the chamber and spaced apart from the first electric heating element(s);
a plurality of hollow coils extending in the chamber from the first end toward the second end, each of the coils having an inlet section and an outlet section; and
one or more fluid inlet conduits in fluid communication with the inlet sections of the coils;
where the fluid inlet conduit(s) each comprise a pre-heating section extending in at least the second end region of the chamber to receive thermal radiation from a portion of the heating elements, and a connection section extending from the pre-heating section to the inlet sections of the coils; and
where the furnace is configured to receive fluid into the fluid inlet conduit(s) such that the fluid flows sequentially through the pre-heating section of each fluid inlet conduit, the connection section of each fluid inlet conduit, and the coils.

2. The radiative electric furnace of claim 1, where the pre-heating section of the inlet conduit(s) flows across the second end region of the chamber.

3. The radiative electric furnace of claim 1, where each coil has an inlet section, an outlet section, and a medial section between the inlet section and outlet section, where the inlet section and outlet section extend in a first direction from the first end of the chamber toward the second end, and the medial section is disposed closer to the second end of the chamber than to the first end; and where at least part of the pre-heating section is disposed between the second end of the chamber and the medial sections of the coils.

4. The radiative electric furnace of claim 1, where the second end region is defined by the 10% of the chamber closest to the second end.

5. The radiative electric furnace of claim 1, where the preheating section defines a plurality of flowpaths.

6. The radiative electric furnace of claim 1, where the inlet section of each of the coils comprises a plurality of tubes each of which is in fluid communication with the medial section of that coil and with the inlet section of the inlet conduit(s).

7. A radiative electric furnace comprising:
a housing defining a radiant heating chamber having a first end and a second end separated from the first end by a chamber length;
one or more first electric heating elements disposed on a first side of the chamber;
one or more second electric heating elements disposed on a second side of the chamber and spaced apart from the first electric heating element(s);
a plurality of hollow first coils, each first coil having an inlet section, an outlet section, and a medial section between the inlet section and outlet section, where the inlet section and outlet section extend in a first direction from the first end of the chamber toward the second end, and the medial section is disposed closer to the second end of the chamber than to the first end;
a plurality of hollow second coils, each second coil having an inlet section, an outlet section, and a medial section between the inlet section and outlet section, where the inlet section and outlet section extend in a second direction from the second end of the chamber toward the first end, and the medial section is disposed closer to the first end of the chamber than to the second end;
one or more fluid inlet conduits in fluid communication with the inlet sections of the first and second coils;
where the furnace is configured to receive fluid into fluid inlet conduit(s) such that the fluid flows sequentially through the inlet sections of the first and second coils, the medial sections of the first and second coils, and the outlet sections of the first and second coils.

8. The radiative electric furnace of claim 7, where the inlet section of each of the first and second coils comprises a plurality of tubes each of which is in fluid communication with the medial section of that coil and with the inlet conduit(s).

9. The radiative electric furnace of claim 1, where the first and second electric heating elements are configured to reach a maximum temperature in excess of 1050° C.

10. The radiative electric furnace of claim 1, where the fluid inlet conduit(s) is coupled to the inlet sections of the coils via a manifold.

11. A steam cracking system comprising:
a quench unit having an quench unit inlet; and
a furnace of claim 1 with the outlet sections of the coils coupled to the quench unit inlet.

12. The steam cracking system of claim 11, where the quench unit comprises a transfer line exchanger (TLE).

13. A method of steam cracking, the method comprising:
directing a fluid from one or more fluid inlet conduits to inlet sections of hollow coils that extend from a first end of a furnace heating chamber toward a second end of the furnace heating chamber, and between first and second electric heating elements disposed on opposing sides of the heating chamber, such that the fluid is heated to a reaction temperature at which a cracking reaction occurs;
where, before reaching the inlet sections of the hollow coils, a preheat section of each fluid inlet conduit(s) pass between the heating elements, at a position closer to the second end then to the first end, such that the preheat section(s) absorb thermal radiation from at least a portion of the heating elements and the temperature of the fluid increases in the preheating section.

14. The method of claim 13, further comprising:
directing the fluid from the outlet sections of the coils to an inlet of a quench unit to reduce the temperature of the fluid to below the reaction temperature and slow or stop the cracking reaction.

15. The method of claim 13, where the hydrocarbon feedstock comprises at least one component selected from the list of components consisting of: naptha, liquified petroleum gas (LPG), and ethane.
